(19) United States
(12) Patent Application Publication
(10) Pub. No.: US 2018/0292256 A1
(43) Pub. Date: Oct. 11, 2018

(54) PORTABLE INTRINSICALLY-SAFE DEVICE FOR ACQUIRING VIBRATION SIGNAL AND METHOD FOR ACQUIRING VIBRATION INFORMATION

(71) Applicant: Qingdao Chuangfeike Intelligent Technology Co., Ltd, Qingdao (CN)

(72) Inventors: Liang WANG, Qingdao (CN); Jie GAO, Qingdao (CN); Lirong WAN, Qingdao (CN); Guangyu ZHOU, Qingdao (CN); Yuanjun WANG, Qingdao (CN); Yi LIU, Qingdao (CN); Shilong MA, Qingdao (CN); Long GAO, Qingdao (CN); Yalin WANG, Qingdao (CN); Jigang WANG, Qingdao (CN); Hang REN, Qingdao (CN)

(21) Appl. No.: 16/004,523

(22) Filed: Jun. 11, 2018

Related U.S. Application Data
(63) Continuation of application No. PCT/CN2016/096329, filed on Aug. 23, 2016.

(30) Foreign Application Priority Data
May 27, 2016 (CN) 201610369571.1

(51) Int. Cl. G01H 11/08; G01P 15/18

(52) U.S. Cl. CPC G01H 11/08; G01P 15/18

(57) ABSTRACT

A portable intrinsically-safe device for acquiring vibration signal comprises a vibration signal acquisition unit, a signal processing unit, a signal storage unit and an intrinsically-safe power source, wherein the vibration signal acquisition unit is connected to the signal storage unit through the signal processing unit; the intrinsically-safe power source supplies power for all the units; the signal processing unit and the signal storage unit are integrally packaged in an intrinsically safe manner. The device solves the vibration signal acquisition from a large portable electromechanical equipment, providing a powerful data information for equipment status monitoring and failure analysis. Particularly, intrinsically safe design satisfies the test requirements when the portable equipment is under a complex and harsh environment of a coal mine well. The device is easy to mount, low in power consumption, easy to control, flexible to use and wide in range of application.

### TECHNICAL FIELD

The present invention relates to a portable intrinsically-safe device for acquiring vibration signal and a method for acquiring vibration information, belonging to the technical field of information acquisition and equipment status monitoring.

### BACKGROUND OF THE PRESENT INVENTION

Vibration detection is an important means for the equipment status monitoring and failure diagnosis. In view of the harsh environment of coal mine wells and the anti-explosion requirements special to the equipment in coal mine wells, data acquisition cannot be performed by some standard test devices. Therefore, the design of simple and easy-to-use acquisition devices is particularly important during the measurement of effective and real data.

The existing vibration detection has been mainly described in the following patents.

Chinese Patent No. CN204649304U provided a portable crystallizer vibration detection system, including a crystallizer and a portable industrial personal computer connected to the crystallizer, wherein a PCI data acquisition card connected to a signal conditioner is provided on the portable industrial personal computer; the signal conditioner is externally connected to a portable sensor cartridge; a three-axis acceleration sensor is provided in the portable sensor cartridge; and, the portable sensor cartridge is disposed on the crystallizer.

Chinese Patent No. 105043729A provided a method for monitoring and warning looseness of a suspended device, including steps of: providing a three-axis acceleration sensor on the suspended device; acquiring, by the three-axis acceleration sensor, vibration information of the suspended device, and reporting the vibration information to a signal processor; by the signal processor, acquiring the vibration information, and searching reference vibration data according to an identifier of the suspended device carried in a message in which the vibration information is transmitted; and, analyzing the vibration information according to the vibration data by the signal processor, and determining the operating status of the suspended device.

Chinese Patent No. CN205032666U disclosed a portable crystallizer vibration detection device special for a continuous casting machine, including a portable sensor cartridge, wherein a three-axis acceleration sensor and a signal transformer connected to the three-axis acceleration sensor are provided in the portable sensor cartridge; the signal transformer is connected to a PCI data acquisition card via a data line; and, the PCI data acquisition card is connected to a portable industrial personal computer.

Chinese Patent No. CN105547451A disclosed a new method for testing the coupling vibration of a wheel space of a high-speed train. The method includes steps of: collecting vibration signals of wheels in the transverse direction, longitudinal direction and axial direction by acceleration sensors in X, Y and Z directions in a sensing portion of a three-axis wireless acceleration sensor, respectively; amplifying the analog vibration signals in the three directions by an amplifier, and processing the signals by a two-order low-pass active filter to increase the signal-to-noise ratio; processing the signals by a signal processing unit to obtain electrical signals which are then stored; and, performing data exchange between a wireless transmission module and the processing unit via an SPI interface so as to realize the wireless transmission of data.

However, the above patent documents are not applicable to the acquisition and processing of vibration signals in a harsh construction environment. Therefore, the real-time effective detection for the equipment in a well has become a technical problem to be urgently solved at present.

### SUMMARY OF THE PRESENT INVENTION

In view of the deficiencies of the prior art, the present invention provides a portable intrinsically-safe device for acquiring vibration signal.

The present invention further provides a method for acquiring vibration information by the device.

The present invention employs the following technical solutions.

A portable intrinsically-safe device for acquiring vibration signal is provided, including a vibration signal acquisition unit, a signal processing unit, a signal storage unit and an intrinsically-safe power source.

The vibration signal acquisition unit is connected to the signal storage unit through the signal processing unit; the intrinsically-safe power source supplies power for all the units; and, the signal processing unit and the signal storage unit are packaged integrally in an intrinsically safe manner. The vibration signal acquisition unit acquires vibration signals of a test device, and the signal processing unit filters and amplifies the vibration signals and then stores the vibration signals in the signal storage unit so that a remote analysis and processing system subsequently analyzes the vibration signals. The vibration signal acquisition unit is mounted on a surface of the test device to monitor its vibration signals in real time, and the signal processing unit and the signal storage unit are mounted in a region away from the vibration source to monitor the vibration signals in real time.

In accordance with the present invention, preferably, the vibration signal acquisition unit is mounted on the test device through a strong magnetic base.

In accordance with the present invention, preferably, the vibration signal acquisition unit is a three-axis acceleration sensor; and, preferably, the vibration signal acquisition unit is a three-axis IEPE piezoelectric acceleration sensor. This sensor has the advantages of excellent anti-interference performance and high signal quality.

In accordance with the present invention, preferably, the signal processing unit includes a signal conditioning unit, a multichannel simultaneous-sampling ADC chip and a single chip microcomputer.

In accordance with the present invention, preferably, the single chip microcomputer is a 32-bit ARM Cortex-M4 single chip microcomputer, and the signal storage unit is an SDHC card. This design has the following advantage: in an actual situation where the vibration monitoring needs to last for several hours sometimes, since a large amount of measured data will be generated, a large-capacity SDHC card is used as a data storage medium in the present invention. The capacity is up to 64G, and thus the requirements for the continuous high-speed vibration signal acquisition are satisfied. In order to realize the data storage during the high-speed sampling, the high-performance 32-bit ARM Cortex-M4 single chip microcomputer reads from and writes into the SDHC card at a high speed through a special SDIO interface. In order to facilitate the introduction of the acquired binary vibration acceleration signals into the remote analysis and processing system for the subsequent signal analysis and processing, in the present invention, the open source file system FatFs commonly used at present is employed during the storage. The acquired binary data is directly stored in a file, .bin, and the remote analysis and processing system can directly read the vibration signal data from the file in the SDHC card, so that the real-time vibration information acquisition efficiency is improved.

In accordance with the present invention, preferably, the vibration signal acquisition unit and the signal processing unit are connected via a shielded cable and a quick aviation connector. Accordingly, the operational safety and the anti-interference performance of the whole device are improved.

In accordance with the present invention, preferably, the intrinsically-safe power source is an integrated intrinsically-safe lithium battery for supplying power in multiple channels. In the present invention, the components are supplied with power by voltage conversion. All the modules and the discrete devices are products with low power consumption. The device can continuously operate for 24 hours to supply power for the vibration information acquisition sensor unit, the communication cable, the low-power-consumption signal conditioning unit and the real-time storage unit. Here, by an integrated power source for supplying power in multiple channels, the electric energy of the 3.7v intrinsically-safe lithium battery is modulated in multiple channels to provide an excitation voltage for the three-axis acceleration sensor and supply power for the conditioning unit and the like.

In accordance with the present invention, preferably, the signal conditioning unit includes a four-order Butterworth anti-aliasing filter. In practical applications, the vibration signals are generally wide in frequency spectrum. In order to obtain vibration signals in useful frequency bands, it is necessary to perform anti-aliasing filtration on the analog signals input into the ADC, to avoid the superposition of useless high-frequency signals onto the low frequency bands. In the present invention, a four-order Butterworth filter having a cutoff frequency of 10 kHz and a stop band at −40 dB of 40 kHz is designed. The four-order Butterworth filter can be applied to useful signals to be measured having a frequency of less than 10 kHz.

A method for acquiring vibration information is provided, including steps of: acquiring areal-timethree-axis vibration signal of a test device with a three-axis acceleration sensor; filtering and amplifying the vibration signals, and storing the vibration signals in a signal storage unit; and acquiring the vibration signal from the signal storage unit and analyzing the vibration signal in real-time or selectively with a remote analyzing and processing system.

In accordance with the present invention, preferably, the method for acquiring vibration information further includes steps of: simultaneously sampling vibration acceleration signals in the three axes by an independent 16-bit multichannel simultaneous-sampling ADC chip, and filtering and amplifying the vibration signals by a four-order Butterworth anti-aliasing filter. This design ensures the integrity and correctness of spatial vibration signals. Meanwhile, in order to reduce the difficulty in designing the anti-aliasing filter in the foreground, the accuracy can be increased by 1.5 bits just by 8× oversampling.

The present invention has the following advantages.

The device addresses the issue of vibration signal acquisition of large portable electromechanical equipment (e.g., a shield tunneling machine, a coal cutter and the like), guaranteeing equipment operating status monitoring and effective data provision for failure analysis. Particularly, the device is specifically designed for intrinsic safety to satisfy the test requirements of portable equipment under a complex and harsh environment of a coal mine well. The device is easy to mount, low in power consumption, easy to control, flexible to use and wide in range of application.

The device is applied to the analysis and studies on the cutting state of a drum of a coal cutter used in the thin coal seam. The acquired large amount of field data verifies the reliability of the device. The device can also be used in a warning system for vibration monitoring and failure diagnosis of the mechanical equipment in a coal mine well, and it has a wide range of application.

The present invention has the following specific advantages:

(1) by a three-axis acceleration sensor with a gyroscope correction function, it is unnecessary to strictly determine the fixation and test direction of the vibration sensor;

(2) by the integrated miniature design, the signal line layout is not to be taken into consideration, and the equipment tracking and protection can be performed effectively;

(3) the device is small in size, light in weight, mounted by strong magnesium, and convenient and reliable;

(4) the intrinsically safe design has high safety and is applicable to the operating environment for fully-mechanized coal mining in a coal mine well; and

(5) the analog-to-digital conversion is performed by the special multichannel simultaneous-sampling ADC chip, so that the simultaneity between channels can be ensured, the problems caused by the non-simultaneous-sampling in three axes are avoided, and the accuracy of the vibration signal acquisition is improved.

### BRIEF DESCRIPTION OF THE DRAWINGS

FIG. 1 is a vibration information acquisition chain in the device for acquiring vibration signal according to the present invention; and

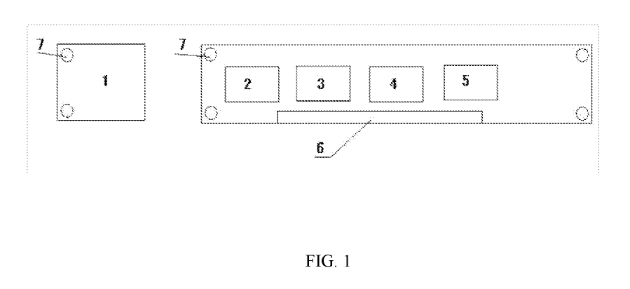

FIG. 2 is the four-order Butterworth anti-aliasing filter according to the present invention,

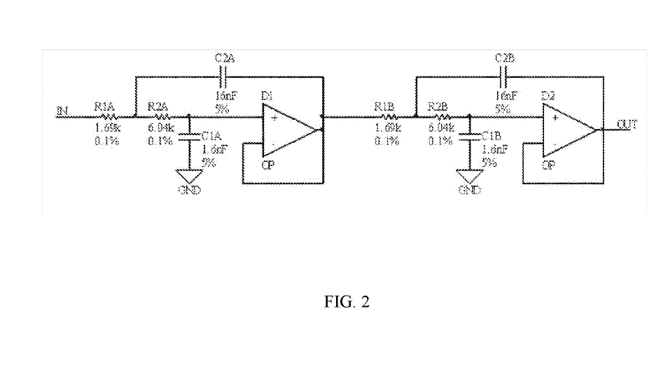

in which:
1: vibration signal acquisition unit;
2: signal conditioning unit;
3: multichannel simultaneous-sampling ADC chip;
4: single chip microcomputer;
5: signal storage unit;
6: intrinsically-safe power source; and,
7: strong magnetic base.

### DETAILED DESCRIPTION OF THE PRESENT INVENTION

The present invention will be described below in detail by embodiments with reference to the accompanying drawings and the present invention is not limited thereto.

### Embodiment 1

A portable intrinsically-safe device for acquiring vibration signal is provided, including a vibration signal acquisition unit, a signal processing unit, a signal storage unit and an intrinsically-safe power source.

The vibration signal acquisition unit is connected to the signal storage unit through the signal processing unit; the intrinsically-safe power source supplies power for the units; and, the signal processing unit and the signal storage unit are packaged integrally in an intrinsically safe manner.

The vibration signal acquisition unit is a three-axis acceleration sensor. Preferably, the vibration signal acquisition unit is a three-axis IEPE piezoelectric acceleration sensor.

### Embodiment 2

The portable intrinsically-safe device for acquiring vibration signal in this embodiment is similar to that described in Embodiment 1, except that the vibration signal acquisition unit is mounted on a test device through a strong magnetic base.

### Embodiment 3

The portable intrinsically-safe device for acquiring vibration signal in this embodiment is similar to that described in Embodiments 1-2, except that the signal processing unit includes a signal conditioning unit, a multichannel simultaneous-sampling ADC chip and a single chip microcomputer.

The single chip microcomputer is a 32-bit ARM Cortex-M4 single chip microcomputer, and the signal storage unit is an SDHC card.

The signal conditioning unit includes a four-order Butterworth anti-aliasing filter.

### Embodiment 4

The portable intrinsically-safe device for acquiring vibration signal in this embodiment is similar to that described in Embodiments 1-3, except that the vibration signal acquisition unit and the signal processing unit are connected via a shield cable and a quick aviation connector. The intrinsically-safe power source is an integrated intrinsically-safe lithium battery for supplying power in multiple channels.

### Embodiment 5

A method for acquiring vibration information by the portable intrinsically-safe device for acquiring vibration signal described in Embodiments 1-4 is provided, including steps of: acquiring a real-time three-axis vibration signal of a test device with a three-axis acceleration sensor; filtering and amplifying the vibration signals, and storing the vibration signals in a signal storage unit; acquiring the vibration signal from the signal storage unit and analyzing the vibration signal in real-time or selectively with a remote analyzing and processing system.

### Embodiment 6

The method for acquiring vibration information in this embodiment is similar to that described in Embodiment 5, except that the method further includes steps of: simultaneously sampling vibration acceleration signals in the three axes by an independent 16-bit multichannel simultaneous-sampling ADC chip, and filtering and amplifying the vibration signals by a four-order Butterworth anti-aliasing filter.

What is claimed is:

1. A portable intrinsically-safe device for acquiring a vibration signal for acquiring vibration signal, comprising a vibration signal acquisition unit, a signal processing unit, a signal storage unit and an intrinsically-safe power source;
the vibration signal acquisition unit is connected to the signal storage unit through the signal processing unit;
the intrinsically-safe power source supplies power for the vibration signal acquisition unit, the signal processing unit and the signal storage unit;
the signal processing unit and the signal storage unit are packaged integrally in an intrinsically safe manner;
wherein the vibration signal acquisition unit is a three-axis acceleration sensor and the signal processing unit comprises a signal conditioning unit, a multichannel simultaneous-sampling ADC chip and a single chip microcomputer.

2. The portable intrinsically-safe device for acquiring a vibration signal of claim 1, wherein the vibration signal acquisition unit is mounted on a test device through a magnetic base.

3. The portable intrinsically-safe device for acquiring a vibration signal of claim 1, wherein the single chip microcomputer is a 32-bit ARM Cortex-M4 single chip microcomputer, and the signal storage unit is an SDHC card.

4. The portable intrinsically-safe device for acquiring a vibration signal of claim 1, wherein the vibration signal acquisition unit and the signal processing unit are connected via a shielded cable and an aviation connector.

5. The portable intrinsically-safe device for acquiring a vibration signal of claim 1, wherein the intrinsically-safe power source is an integrated intrinsically-safe lithium battery with a multi-channel power supply.

6. The portable intrinsically-safe device for acquiring a vibration signal of claim 1, wherein the signal conditioning unit comprises a four-order Butterworth anti-alias filter.

7. A method for acquiring vibration information by the portable intrinsically-safe device of claim 1, comprising steps of:
acquiring a real-time three-axis vibration signal of a test device with a three-axis acceleration sensor;
filtering and amplifying the vibration signal, and then storing the vibration signal in a signal storage unit;
acquiring the vibration signal from the signal storage unit and analyzing the vibration signal in real-time or selectively with a remote analyzing and processing system.
